(19) United States
(12) Patent Application Publication
(10) Pub. No.: US 2014/0222655 A1
(43) Pub. Date: Aug. 7, 2014

(54) Method and System for Automatic Regulatory Compliance

(71) Applicant: AML Partners, LLC, Franklin, NH (US)

(72) Inventor: Francis A. Cummings, Salisbury, NH (US)

(21) Appl. No.: 14/077,923

(22) Filed: Nov. 12, 2013

Related U.S. Application Data
(60) Provisional application No. 61/725,779, filed on Nov. 13, 2012.

(51) Int. Cl. G06Q 40/02

(52) U.S. Cl. CPC G06Q 40/025
USPC 705/38

(57) ABSTRACT

A system and method implementing an automated database-driven web interface operable to automatically ensure compliance with various laws. A customizable and dynamically-generated information-collection system enables various businesses, including banks, to comply with various laws relating to financial transactions, including the Bank Secrecy Act, the Patriot Act, Dodd-Frank Act, and FATCA.

### RELATED APPLICATIONS

This application claims priority to Provisional Patent Application U.S. Ser. No. 61/725,779 which was filed on Nov. 13, 2012, the contents of which are relied upon and incorporated by reference.

### TECHNICAL FIELD

The present disclosure relates to financial regulatory compliance. More particularly, the present disclosure relates to computer-implemented systems and methods for automatically conducting customer due diligence to ensure compliance with the requirement of various financial regulations, including but not limited to the Bank Secrecy Act and the U.S. Patriot Act.

### BACKGROUND

There are many laws requiring businesses to detect and prevent money laundering, terrorist financing and fraud. For example, the Financial Crimes Enforcement Network (http://www.fincen.gov) was setup by the U.S. Department of the Treasury to safeguard the financial system from illicit use and combat money laundering and to promote national security through the collection, analysis, and dissemination of financial intelligence and strategic use of financial authorities.

Additionally, businesses can benefit from continuously monitoring behavioral risk, including employee risk and vendor risk.

Depending on the size of the business, complying with these laws could require multiple employees reviewing and analyzing various transactions to ensure compliance.

Prior to this invention, most information collections were done through paper form that was stored in cabinets and often lost, which made achieving 100 percent compliance nearly impossible. Though there are other tools that have automated this process, none have given the control to the banking user; these other tools require technical intervention to change the information collection process.

As evidenced by the numerous investigations conducted by the Financial Crimes Enforcement Network (http://www.fincen.gov), there is a strong long-felt but unsolved need to address the failure of the financial industry to efficiently fully comply with various financial regulations.

There is a need for a computer-implemented automated database-driven web interface operable to automatically ensure compliance with various laws, including the Bank Secrecy Act and the U.S. Patriot Act.

There is a further need for a true dynamically-generated information collection system that enables banking customers to comply with various laws, including the Bank Secrecy Act, the Patriot Act, Dodd-Frank Act, and FATCA.

There is yet a further need to provide methods and systems that are customizable so that non-technical personnel may easily and quickly adapt the data collection and risk analysis to meet their institution's requirements and to adjust to changing regulations and regulator requests.

There is yet a further need for an automated computer-implemented methods and systems that are capable of being adapted to almost any industry that requires knowledge of their customers and management of data collection.

### SUMMARY

One aspect of the present disclosure provides a method and a system including a database-driven web interface designed to ensure compliance with various laws, including the Bank Secrecy Act and the U.S. Patriot Act.

Another aspect of the present disclosure provides a custom computer-implemented system running a custom software application that takes into account the full characteristics of each banking customer entered and establishes first a Bank Secrecy Act-required risk assessment and then based upon the aforementioned characteristics and the risk assessment generates a custom set of dynamically presented information uploads and collections.

In another aspect of the present disclosure, the aforementioned information uploads are fully configurable by the non-technical laymen.

Another aspect of the present disclosure provides a method implemented in a custom computer system running a custom software application enabling a user to control a dynamically-generated risk assessment report.

One of the objectives of the invention is to give authorized users complete control over the risk assessment of any customer on-boarded. As described in detail below, the authorized user defines what questions are to be asked of each customer based on each customer's unique characteristics, the authorized user defines what questions are to be used in the Risk Engine as factors, the authorized user defines what questions will override the Risk Engine, and the authorized user defines external factors that will override the calculated Risk. The output of the final risk is used to generate additional questions/documents to be collected and to feed downstream systems that monitor for illicit activity

### BRIEF DESCRIPTION OF THE DRAWINGS

FIG. 1 is an exemplary flow chart demonstrating the risk calculation according to one embodiment of the present invention.

FIG. 2 is an exemplary flow chart demonstrating the model score calculation according to an embodiment of the present invention.

FIG. 3 is an exemplary flow chart demonstrating the manual risk adjustment according to an embodiment of the present invention.

FIG. 4 is an exemplary flow chart demonstrating the risk class calculation according to an embodiment of the present invention.

FIG. 5 is an exemplary flow chart demonstrating the application of item overrides according to an embodiment of the present invention.

FIG. 6 is an exemplary flow chart demonstrating determining relevant questions according to an embodiment of the present invention.

FIG. 7 is an exemplary flow chart demonstrating applying question overrides according to an embodiment of the present invention.

### DETAILED DESCRIPTION

This disclosure relates to a database-driven web interface specific to financial due diligence and the compliance requirements of the Bank Secrecy Act and the U.S. Patriot Act. In one aspect of this invention, an application takes into account the full characteristics of each banking customer entered and establishes first a Bank Secrecy Act-required risk assessment and then based upon the aforementioned characteristics and the risk assessment generates a custom set of dynamically presented information uploads and collections. These information uploads may be fully configurable by the non-technical laymen.

In one aspect of the present invention the standard banking user is given complete control over the institution's compliance program by providing a fully user-configurable risk assessment and information collection system with no need for technical staff.

In one embodiment of the present invention, various software development tools may be used to develop a three-tier web-based database-controlled information collection, storage, and retrieval system. The software tools include but are not limited to Web 2.0 methodologies, Microsoft SQL Database Management System, C# programming language, with HTML, JavaScript, and Ajax Controls.

The systems and methods according to one aspect of the present invention may use both static and dynamically generated information collection points. The invention may use these points to determine the characteristics of any given banking customer; based upon those characteristics, the system may use the weighted-average method to generate a risk score that assesses both the possibility and probability that a given customer will attempt illicit financial activity through a banking institution.

Some of the unique aspects of this invention include: a) the risk model, b) the question-management subsystem, and c) the FATCA implementation model.

The following is an overview of the Risk Model. One of the innovative aspects of this invention is the Dynamic Multi-dimensional Risk Modeling. This proprietary risk-modeling system allows a provisioned user or administrator to create and implement a custom Risk Model that can be applied to any Customer. The Risk Model that is applied to a customer is determined by the customer type, also known as Entity type.

When a Risk model is initially created, it is not associated to any given entity type. This association is done through the creation and assignment of a risk model to a given entity type through the Risk Model Manager.

The following is an overview of the Risk Model Manager. The Risk Model Manager is responsible for defining risk factors that are based on existing data within the systems and methods according to this invention. The data used to create a risk factor is derived from any base table within the system that can be assigned a risk score and is used as a response to any given question or selected customer data.

Once Risk Factors are created, they can be categorized to clearly define the application or target of a risk factor. There can be as many risk factors as required. In one embodiment of the present invention, the maximum number of risk factors that can be associated with a particular Risk Model is one thousand risk factors per risk model as Factor weighting percentage is limited to 0.001 percent.

The risk modeling system according to this invention may implement weighted average modeling. When creating a Risk Model within the Risk Model Manager, the user is not only determining the risk factors within a given risk model, but the user is also determining the factor weights, factor alias names, display sequence ordering, independent risk item scores within each risk factor, and independent risk overrides on any given item within any given factor.

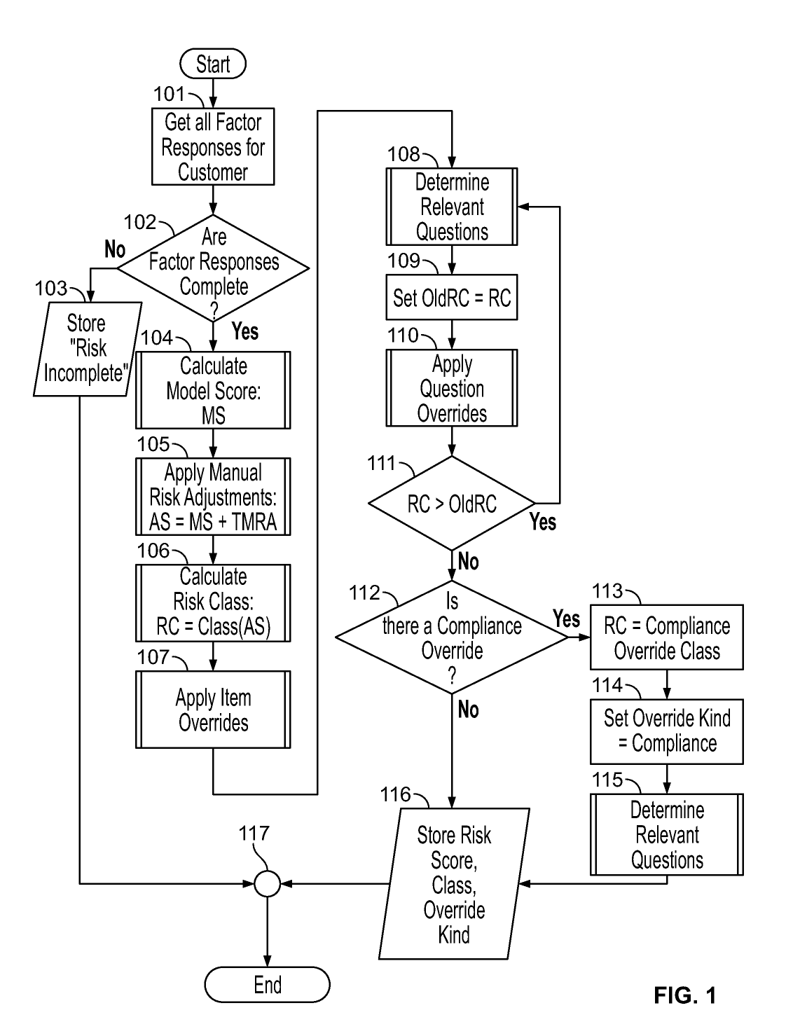

FIG. 1 is an exemplary flow chart demonstrating the risk calculation according to one embodiment of the present invention. Risk Calculation is performed on a per-customer basis. The variables involved are local to the calculation algorithm. They are not stored until the algorithm explicitly indicates.

The algorithm is broken down into subroutines as indicated by the references to subsequent figures. The “Determine Relevant Questions” subroutine is used in more than one place, as indicated.

The sequence of parts from 108 to 111 inclusive will be executed at most three times, because there are only three Risk Classes, and Question Overrides can only increase Risk Class. The following description of the steps followed are exemplary.

Step 101: The database is queried for the responses for the customer to each factor in the customer's risk model.

Step 102: Does each factor in the customer's model have a response?

Step 103: The customer's risk is stored as “Incomplete” due to missing responses for at least one factor.

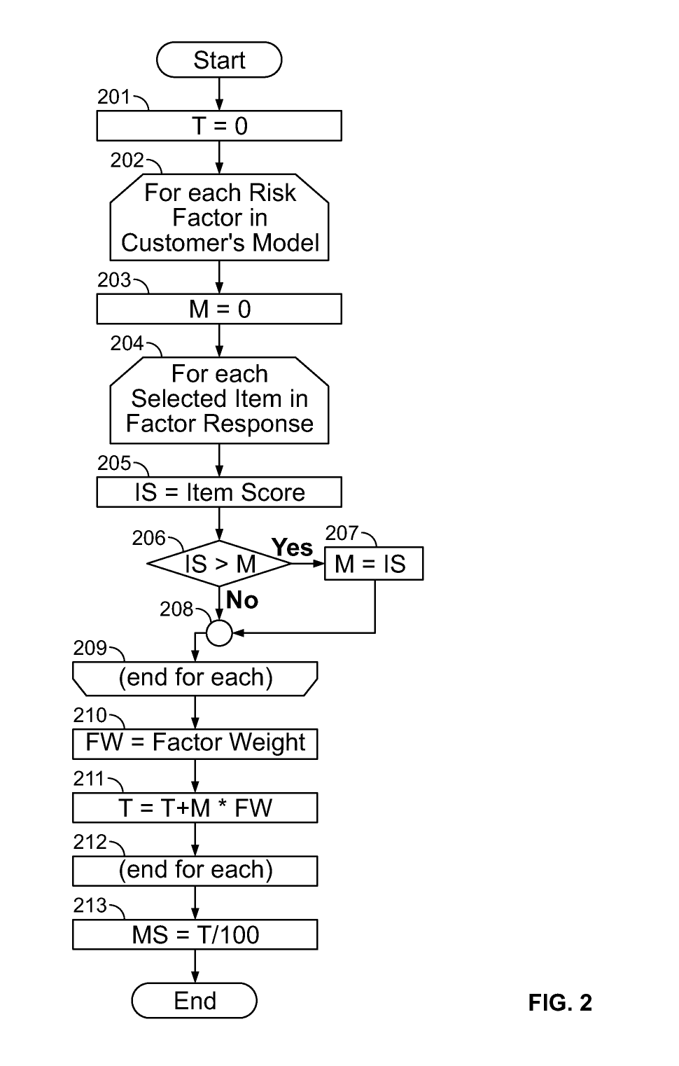

Step 104: See FIG. 2—Calculate Model Score—the result is stored in variable “MS”

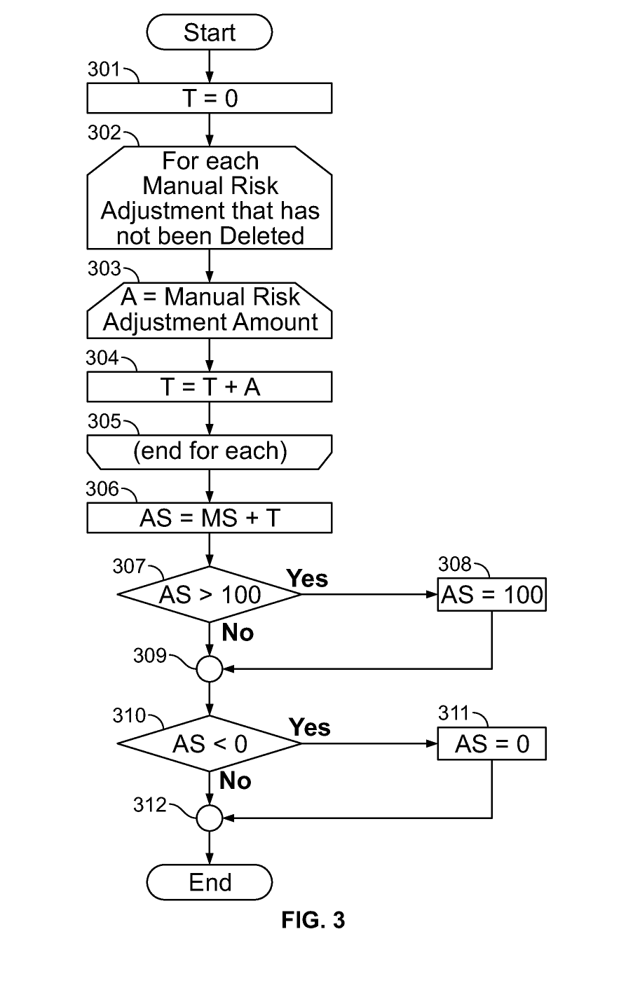

Step 105: See FIG. 3—Apply Manual Risk Adjustments—the result is stored in variable “AS”

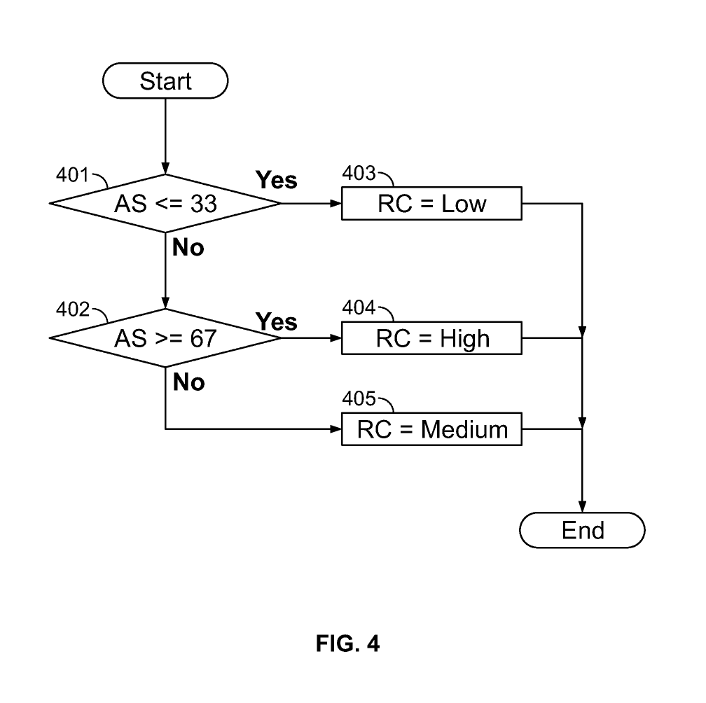

Step 106: See FIG. 4—Calculate Risk Class—the result is stored in variable “RC”

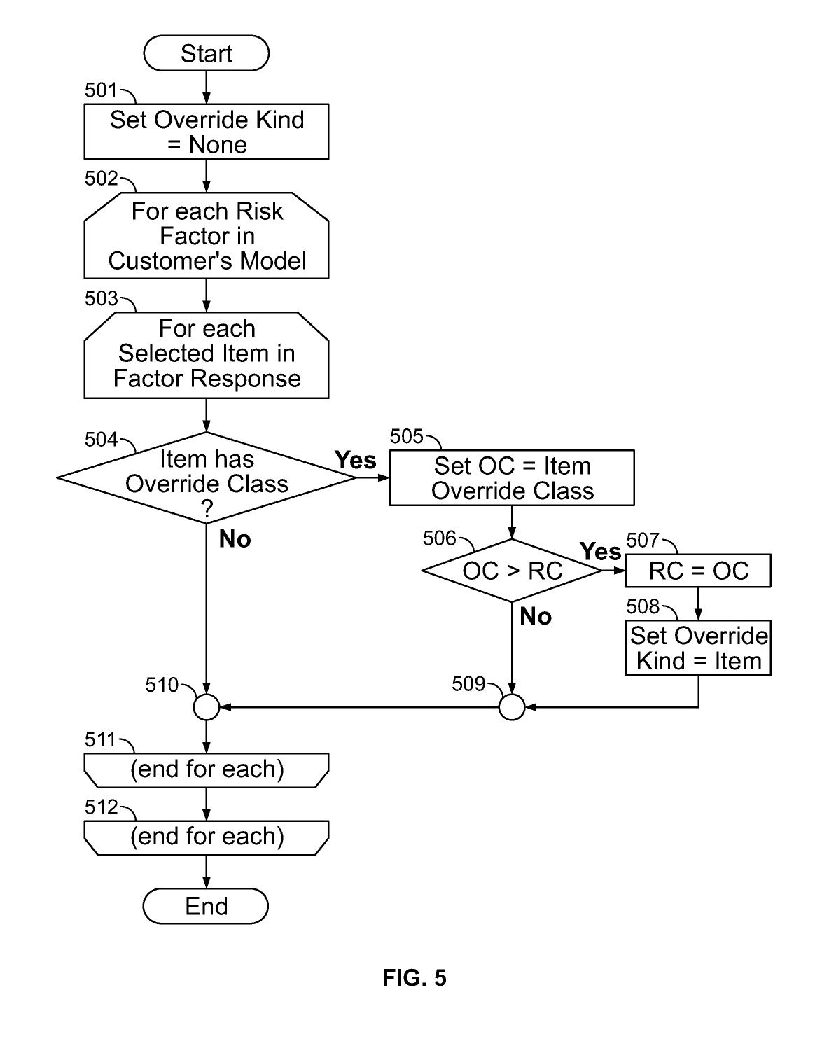

Step 107: See FIG. 5—Apply Item Overrides—the variables “Override Kind” and “RC” may be modified.

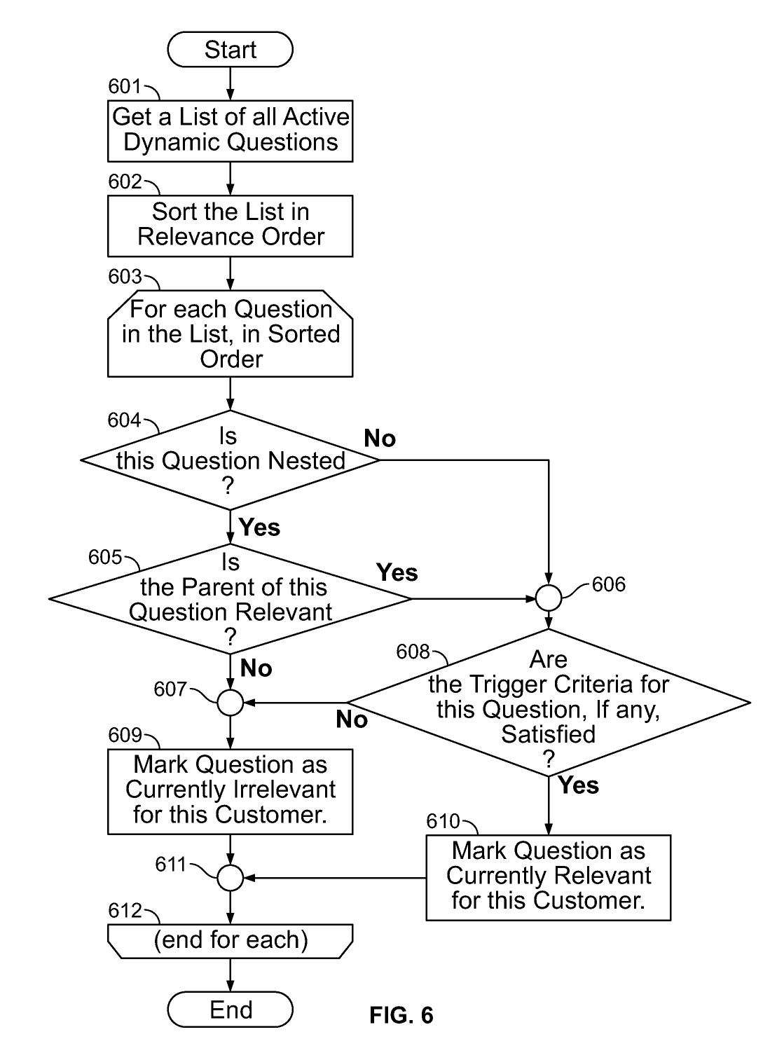

Step 108: See FIG. 6—Determine Relevant Questions

Step 109: Variable “RC” is copied to “OldRC” for later use.

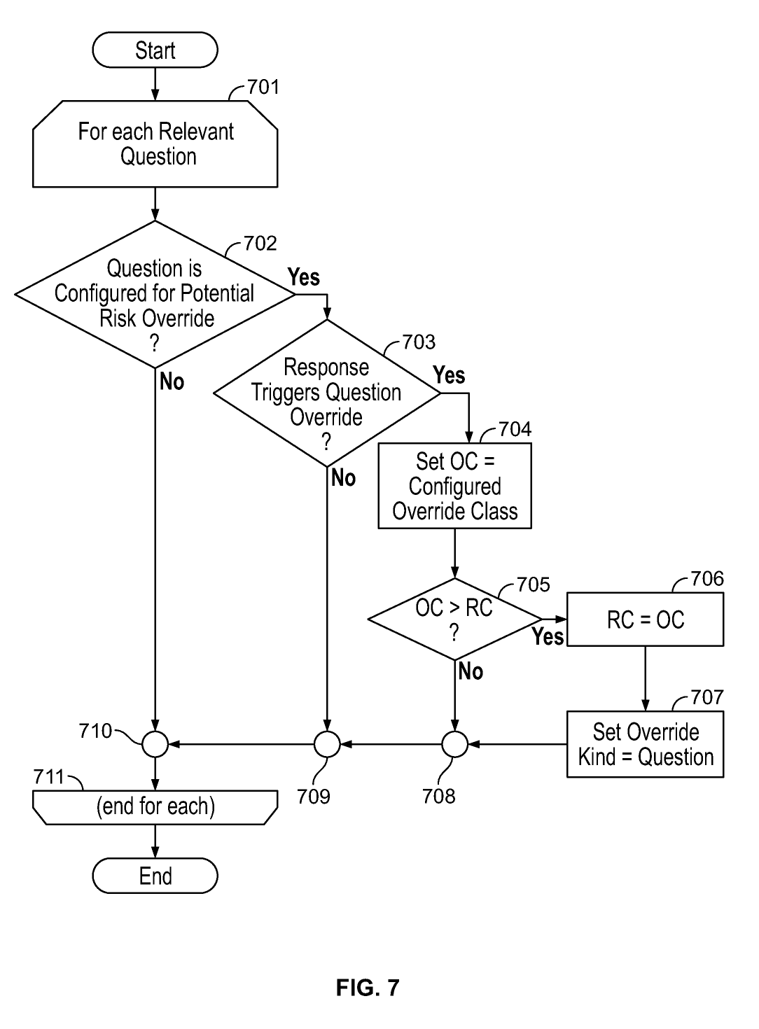

Step 110: See FIG. 7—Apply Question Overrides—the variables “Override Kind” and “RC” may be modified.

Step 111: Is variable “RC” now greater than “OldRC”? For comparison purposes, the values under comparison satisfy the following inequality: LOW<MEDIUM<HIGH

Step 112: Is there a compliance override stored for this customer?

Step 113: Set variable “RC” to the risk class selected by compliance.

Step 114: Set variable “Override Kind” to “Compliance”

Step 115: See FIG. 6-Determine Relevant Questions

Step 116: The following variables are stored for the customer, concluding its risk calculation: “AS” (Adjusted Score), “RC” (Risk Class), “Override Kind”.

The flow chart in FIG. 1 converges after part 116 and part 103 converges.

FIG. 2 is an exemplary flow chart demonstrating the model score calculation according to an embodiment of the present invention. This subroutine generates the model score before any adjustments are applied. The nested loop assures that multiple select factors are handled correctly.

Step 201: Set variable “T” to value 0.

Step 202: Loop up to part 212 for each Risk Factor in the customer's Risk Model.

Step 203: Set variable “M” to value 0.

Step 204: Loop up to part 209 for each Item selected in the customer response to the current Risk Factor.

Step 205: Set variable “IS” to the score of the current selected Item. The Item's score is the score stored with the Item in the corresponding system data table, unless the Item score has been overridden in the Customer's Risk Model, in which case that Item Override Score is used instead.

Step 206: Does the value of variable “IS” exceed that of “M”?

Step 207: Copy variable “IS” to “M”.

Step 208: Flow after part 207 and the negative branch from 206 converges.

Step 209: Repeat the loop that started with part 204 until all selected Items for the current Risk Factor have been processed.

Step 210: Set variable “FW” to the Factor Weight of the current Risk Factor.

Step 211: Add the product of variables “M” and “FW” to variable “T”

Step 212: Repeat the loop that started with part 202 until all Risk Factors in the Customer's Risk Model have been processed.

Step 213: Set variable “MS” to “T” divided by 100.

FIG. 3 is an exemplary flow chart demonstrating the manual risk adjustment according to an embodiment of the present invention. This subroutine includes the manual risk adjustments in the risk calculation, whereby Compliance is able to add or subtract to or from the Model Score (“MS”) for specific reasons. The result is the Adjusted Score (“AS”).

Step 301: Set variable “T” to value 0.

Step 302: Loop up to part 305 for each Manual Risk Adjustment that has been stored for this Customer that has not been marked as deleted.

Step 303: Set variable “A” to the Amount of the current Manual Risk Adjustment.

Step 304: Add “A” to variable “T”

Step 305: Repeat the loop that started with part 302 until all applicable Manual Risk Adjustments have been processed.

Step 306: Set variable “AS” to the sum of variables “MS” and “T”

Step 307: Does variable “AS” exceed 100?

Step 308: Set variable “AS” to 100.

Step 309: Flow after part 308 and the negative branch of 307 converges.

Step 310: Is variable “AS” negative?

Step 311: Set variable “AS” to 0.

The flow chart in FIG. 3 converges after part 311 and the negative branch of 310.

FIG. 4 is an exemplary flow chart demonstrating the risk class calculation according to an embodiment of the present invention. The customer Risk Class (“RC”) is initially calculated from the Adjusted Score (“AS”). It may be overridden by subsequent parts of the overall algorithm.

Step 401: Is variable “AS” less than or equal to 33?

Step 402: Is variable “AS” greater than or equal to 67?

Step 403: Set variable “RC” to “LOW”.

Step 404: Set variable “RC” to “HIGH”.

Step 405: Set variable “RC” to “MEDIUM”.

FIG. 5 is an exemplary flow chart demonstrating the application of item overrides according to an embodiment of the present invention. This subroutine includes the first type of override in the risk calculation: the Risk Class “RC” is subject to an Item Override when any Item configured for such an override is selected in the response to any Risk Factor in the Customer's Risk Model. Item Overrides can only raise the risk class.

Step 501: Set variable “Override Kind” to “None”.

Step 502: Loop up to part 512 for each Risk Factor in the Customer's Risk Model.

Step 503: Loop up to part 511 for each Item selected in the customer response to the current Risk Factor.

Step 504: Is the current selected Item configured for an Item Override?

Step 505: Set variable “OC” to the configured Item Override Risk Class for the current selected Item.

Step 506: Is variable “OC” greater than RC? The values under comparison satisfy the following inequality: LOW<MEDIUM<HIGH

Step 507: Copy variable “OC” to “RC”.

Step 508: Set variable “Override Kind” to “Item”.

Step 509: Flow after part 508 and the negative branch of 506 converges.

Step 510: Flow after part 509 and the negative branch of 504 converges.

Step 511: Repeat the loop that started with part 503 until all selected Items for the current Risk Factor have been processed.

Step 512: Repeat the loop that started with part 502 until all Risk Factors in the Customer's Risk Model have been processed.

FIG. 6 is an exemplary flow chart demonstrating determining relevant questions according to an embodiment of the present invention. The relevance of Dynamic Questions to a particular Customer can be determined in part by the Risk Class of the Customer. Dynamic Questions can, in turn, raise the Risk Class of the Customer. This subroutine determines which questions a relevant to the Customer for a particular Risk Class. Subsequent parts of the overall algorithm assure that if the Risk Class is later raised for any reason, relevance of Dynamic Questions is appropriately recalculated.

Step 601: The database is queried to return a list of all Dynamic Questions in the system that are marked as “Active.”

Step 602: The list returned in part 601 is sorted into “Relevance Order”, by grouping questions on the “Additional Information” tab before questions on other tabs, and by grouping parents of nested questions before the questions nested under them. This assures that every case where question A might determine the relevance of question B (ignoring question overrides themselves) is always evaluated A before B.

Step 603: Loop up to part 612 for each Question in the sorted list that results from part 602.

Step 604: Is the current Question nested under another question?

Step 605: Has the parent of the current Question been determined relevant?

Step 606: Flow from the negative branch of part 604 and the positive branch of part 605 converges.

Step 607: Flow from the negative branch of part 605 and the negative branch of part 608 converges.

Step 608: Are the trigger criteria for the current Question, if any, entirely satisfied? This question is answered in the positive if there are no trigger criteria configured for the current Question.

Step 609: Mark the question as currently NOT relevant for this customer.

Step 610: Mark the question as currently relevant for this customer.

Step 611: Flow after part 609 and after part 610 converges.

Step 612: Repeat the loop that started with part 603 until all Questions in the sorted list have been processed.

FIG. 7 is an exemplary flow chart demonstrating applying question overrides according to an embodiment of the present invention. This subroutine includes the second type of override in the risk calculation: the Risk Class “RC” is subject to a Question Override when any Question configured for such an override has a response that matches the criteria configured for the Question to trigger the Override. Question Overrides can only raise the risk class.

Step 701: Loop up to part 711 for each Question that has been determined to be currently relevant.

Step 702: Is the current Question configured to potentially cause a Risk Override?

Step 703: Does the response for this Customer to the current Question match the criteria for which the Question is configured to cause a Risk Override?

Step 704: Set variable “OC” to the configured Override Risk Class for the current Question.

Step 705: Is variable “OC” greater than RC? The values under comparison satisfy the following inequality: LOW<MEDIUM<HIGH

Step 706: Copy variable “OC” to “RC”.

Step 707: Set variable “Override Kind” to “Question”.

Step 708: Flow after part 707 and the negative branch of part 705 converges.

Step 709: Flow after part 708 and the negative branch of part 703 converges.

Step 710: Flow after part 709 and the negative branch of part 702 converges.

Step 711: Repeat the loop that started with part 701 until each Question that has been determined to be currently relevant has been processed.

Risk Factor Meta Data: A risk factor is defined by its Meta Data. This meta data contains information that describes the associated data elements that make up the risk factor. The following is a general description of some of the information contained in the factor meta data: Source table of risk factor items; Source table Score field definitions; Source table Primary key definitions; Source table score data types; Response table location; Response field definitions; Response primary key definitions; Foreign keys definitions (if applicable); Foreign key table definitions; Foreign key table definitions.

The use of Meta data to describe a risk factor allows any base table within the invention that would be a potential response, to be used as a risk factor.

Moreover, when using the System Data Manager within this invention, any data table added to the system may run an automatic process that generates the meta data describing the new data table. This allows virtually any data table added to the system implementing the invention to become a risk factor.

Dynamic queries within the system accomplish the task of retrieving the response data and linking the response to the original base table.

Multi-dimensional Factoring: A risk factor within this invention need only be defined once. Any risk factor can be used within any risk model. This invention may use a weighted average risk model. Therefore, each risk factor must carry a weight within a given model. As previously described, the number of risk factors is limited to one thousand factors per model. However, each Entity type within a given implementation according to this invention can have a specific risk model.

Each risk model according to this invention could potentially use the same risk factor. The multi-dimensional architectural design allows the same risk factor to be re-defined for each and every risk model to which the factor is applied.

For example, in Risk Model A, the risk factor Y could have a weight of 2 percent and contain an alias name of “My Y Factor.” While in Risk Model B, the same risk factor Y can be used, but the weight can be changed to 50 percent and the alias name of the risk factor can be “Your Y Factor.” Therefore, the same risk factor dimensions can be viewed as the following: Risk Factor X Number of Models=n dimensions

The dimensional aspect of a Risk Factor Item can also be viewed in the same manner. Each risk factor uses a specific data table to derive the score for the factor item used as a response. This invention allows each risk item within a given factor to be redefined on a per-model basis. The term redefined means that the risk item within a given risk factor can take on a new score or be overridden to predefined risk override of Low, Medium or High risk.

For Example, looking back to Risk Models A and B in the previous example, assume that the risk factor Y contains an Item called “YES.” In Risk Model A this item has a risk score of 45 and no risk override.

The same risk item in Model B, Risk Factor Y could have a score of 10 and no Risk Override.

If we introduce a third risk model to this example, called Model Z, we could use Risk Factor Y, define a Factor weight of 25 percent, give the Risk Item “YES” an Item score of 75 and override this particular risk item (at any time) to HIGH risk. Therefore, the dimensions for an item, without a risk override applied, can be viewed as: Risk Factor X Number of Models X 100=n dimensions

The dimensions for an item containing an assuming only overrides applied can be viewed as: Risk Factor X Number of Models3=n dimensions

The dimensions for an item with an inter-mix of both overrides and new scores applied is exponential.

Item Overrides and New Item Score definitions: Risk Item score and Overrides as described above are defined on a per Item, per Factor, per Model basis. However, only if the Item information has been changed within a specific model will the risk item be added to the table “ModelFactorItem.” This table may hold the definition for the updated score and may override information for a specific Risk Item as it applies to a specific Factor within a specific Risk Model.

Item Overrides are defined in the “ItemOveride” table, which may contain the override risk class information and a reason for the override. Entries in this table may be linked to the “ModelFactorItem” table.

Integrated SURETY-CDD Risk Engine (SRE): In one embodiment of the present invention, SURETY-CDD is capable of providing real-time risk analysis through the implementation the SURETY-CDD Risk Engine.

Utilizing the in-memory Risk Objects that are created and continually updated while working on an opened customer record, the SURETY-CDD Risk Engine (SRE) processes all of the risk data associated with a customer record, based on the Risk Model associated with the customer Entity Type.

The SRE also takes into consideration any risk overrides that may be in place for any given risk item. In order to preserve the performance characteristics and conserve resources, special consideration is taken into account within SURETY-CDD as to whether the risk engine should process the Risk Model. These special considerations include: Question overrides; and Auto-Risk Triggers. In most cases, the SRE determines overridden risk and generated risk result accordingly.

The SRE may store one of the following metadata about each kind of factor:

TableName—the table that stores the available items within the factor;

KeyFieldName—the name of the primary key column in that table;

ItemFieldName—the name of the column in that table that holds the name of each item;

ScoreFieldName—the name of the column in that table that holds the risk score of each item;

ScoreDataType—how that table stores the score per item;

ResponseType—whether the factor is static or dynamic; and/or

UseFK—if true, then the primary key of the selected item is stored in the response table, otherwise the item is stored by name.

The following additional metadata may be used only for static factors:

ResponseTable—the table where the selected items with a factor are stored; and/or

ResponseField—the name of the column in the ResponseTable where the selected item(s) are stored.

Once all factors are created by authorized users, the users must add a weight as a percentage of 100 for each factor they create. The system uses the weighted-average method of calculating a customer's score based on the imputed data for those customers. Once a score is calculated, the system makes available four types of overrides to determine the final Risk of each customer; each of these four override options facilitates authorized users to make dynamic decisions that create customizable risk assessments for individual customers, entire customer types, and so on.

The four options for overriding risk require authorized users to make override decisions based on one or more of the following options: 1) Authorized users may add to or subtract from individual customer scores calculated automatically by the Risk Engine. 2) Authorized users may specify one or more factor item(s) as triggers for a prescribed risk-classification override based on specific factor-item responses identified by the authorized users. 3) Authorized users may include Yes/No question(s) and specify that certain answers to that question(s) will create a risk override to low/medium/high risk as prescribed by authorized users. And 4) the Manager of the system (for example, a Chief Compliance Officer using the Dynamic Risk Engine within the SURETY-CDD application) may choose to override the risk directly and so indicate this choice to override (with recorded explanatory notes and system logging) within the customer record located within the system

Among other features described herein, the above-mentioned four override options (i.e., the override system) make the Risk Engine truly unique when combined with the user-configured question-management system.

Data Architectural Overview: FIG. 2 is an exemplary Risk Model Architecture according to an embodiment of the present invention.

According to one embodiment of the present invention, the risk modeling system may rely on numerous stored procedures to manage database communications and the program code that makes up the SURETY-CDD Application in order to fully implement this architecture. This program code includes: SURETY-CDD Application GUI (Application GUI); SRE (SURETY-CDD Risk Engine); Risk Model Manager (Model management GUI); and System Data Manager (Data Management GUI).

These program code sections of SURETY-CDD, as a whole, provide Customer Data input, Risk Model Processing, and Risk Model Management respectively.

Question-management Subsystem: In one embodiment of the present invention, SURETY-CDD includes the means for a user to add, edit, and disable the questions that appear throughout the application. Questions modified and saved through the Manage Questions page are saved in a table in a SQL database that contains all of the data necessary to dynamically generate those questions.

Basic Functionality: In one embodiment of the present invention, when a user adds or edits a question, they have a series of options that affect where, when, and how the question will appear in the application, as well as how the application responds to the question being answered. The user can choose whether the question appears on the PEP page, the NFFE page, or on the CustomerForm page on either the Customer Details tab or the CDD/EDD tab. The order in which questions appear in the selected section can also be modified.

The user can write his own question text and choose the Category to which the question belongs. Question Category groups questions and dictates what the header text will be for that group on the CDD/EDD tab. Choosing a question category of “PEP” or “NFFE” causes the question to appear on the PEP or NFFE page, respectively. All questions that are created for the Customer Details section automatically have a Question Category of Customer Details. The user can choose to have a Question Category and its associated questions only appear when a specific question has been answered with a given response. More information about this functionality can be found in the “Trigger Questions and Nested Questions” section below.

The user can make the question either Active or Inactive, which causes the question to appear or not appear in the application, respectively. If Inactive is selected, the user has the option to set the date on which the question will automatically be made Active. If the user enters a date, the SURETY-CDD nightly process will update the Active field in the database on the given date, and the question will be generated in the application from that point forward.

A question can be specified as Required. Required questions are generated in the application with a Required Field Validator that will not allow the user to save the responses in an application section until all Required questions in that section are completed. Additionally, when a user attempts to advance a customer record to the status of CDD Complete, the number of required CDD/EDD questions are tallied and compared to the number of required CDD/EDD questions that have been answered. If the two numbers are not the same, the customer record cannot advance. The same is true of Customer Details questions when the user attempts to advance to Details Complete.

The user can choose to make a question only appear if the customer has a given risk class, and/or if it has been indicated that the customer is operating, non-operating, or both.

Trigger Questions and Nested Questions: In one embodiment of the present invention, the user can choose to make a question only appear on the Details or CDD tab when a Customer has a given Entity type. Entity type is a field in the Customer table that is set when the Customer Information tab is saved.

The user can choose to make a question on the Customer Details tab trigger specific Question Categories on the CDD/EDD tab based on the response given. Questions that the user has designated as belonging to these Question Categories will only appear when the appropriate response was selected for the trigger question.

He or she can also choose to make a question trigger nested questions; that is, questions that will appear indented below the primary question when the correct yes/no response is given. Nested questions retain all functionality of primary questions. Questions can be nested down to the third level; that is, if Question A is the primary question, and Question B is the first nested question, one additional sublevel of questions can be generated based on the response to Question B.

Control Types: In one embodiment of the present invention, the user can select the control type of the question, which dictates whether the application generates a text box, radio button, drop down list, file upload button, or calendar control next to the question. Certain controls have options to allow for additional functionality.

TextBox: In one embodiment of the present invention, when the end user enters text into the TextBox control and clicks the save button, the text is saved to the Response table along with reference to which customer and which question the response is associated with. This information is used to display the response in various places in the application (e.g. the Review page and the Compliance Review tab). The user can choose to make the TextBox single-line or multi-line; to require that the response is numeric; to indicate that the response is a Shipping Vessel ID; or to indicate that the response is a name(s) that will be screened by the application.

RadioButtonYN: In one embodiment of the present invention, questions with the control type of RadioButtonYN are generated with two radio buttons next to it, one with a value of “Yes” and the other with a value of “No”. When the user selects one of these buttons and saves, the value “true” or “false” are inserted to the Response table in the same way the text from a TextBox control is saved.

The user can choose to make questions with the control type RadioButtonYN automatically cause a customer to have a risk level of “high”, depending on the response to the question. When responses are saved, if the response to a High Risk Trigger Question matches the response that has been chosen as the trigger in Question Management, the QuestionOverride bit in the rm_Risk table is set to “true”. After the application calculates a customer's risk, it checks this field and overrides the calculated risk with “high” if the bit is “true”.

The user also has the option to have the question trigger an escalation to Compliance. When this feature is enabled, and a user attempts to advance a customer's status to “Awaiting CDDU Approval”, the application loops through all the Compliance Escalation questions and checks the responses for that customer. If the response matches the response that has been chosen as the trigger in Question Management, the is instead put in status “Automated Compliance Review”.

FileUpload: In one embodiment of the present invention, attachments uploaded by a file upload button are saved in the Attachments table with the information necessary to generate a link to download or view that attachment directly underneath that same file upload button. The link appears as an image button corresponding to the type of file that was uploaded in a table containing information related to the file (e.g. upload date, the user who uploaded the file, when the file will expire).

The user can indicate that the file uploaded for this question require an expiration date. If they do so, they must enter the number of days prior to that date that they want to system to start generating e-mail warnings. Now, when a user uploads a file for this question, they are prompted to enter an expiration date. The SURETY-CDD nightly process looks for files that have an expiration date, and selects all those that are within the given number of days from expiring. The nightly process then sends e-mails to the RMs and Managers associated with the customers who have files that have expired or will expire within that window. These e-mails specify which customers and which files have expired or will expire.

DropDownList: In one embodiment of the present invention, when a user chooses DropDownList as the control type in the Question Management system, they must select a table from a list. This is the table that will be used to populate this DropDownList control when the question is generated. Users can add or modify a system table using the Manage System Data feature, and then choose that table to populate the DropDownList control.

Calendar: In one embodiment of the present invention, questions with a control type of Calendar are generated with a TextBox and an Ajax CalendarExtender. The user can then enter a date into the TextBox or choose a date on the CalendarEntendar.

Dynamic Question Generation: In one embodiment of the present invention, all of the questions created through the Question Management system are saved to the database in the Question table. When a customer record is opened in the application, the code queries the database and selects a list of Active questions for each section of the application (e.g. Customer Details, CDD/EDD, PEP, NFFE). It also attempts to select data from the Response table that correspond to those questions and the chosen customer.

The code then loops through these lists and filters out questions that should not appear, whether that's because a Question Category trigger question hasn't been answered correctly, or the customer isn't the correct Entity type or Risk Category, or the question is a nested question (these are handled later). Using the filtered lists, the code starts making tables, putting the appropriate Question Category as a header where necessary. A switch statement takes the control type and decides which controls need to be created and placed in the table, including Required Field Validators. If there is a response in the Response table that corresponds to this customer and this question, the response is added to the control.

When nested questions are saved in the Question Management system, the TriggerSubQs field in the Question table is set to “true” for the question that triggers them. As the code loops through the questions, adding them to the table, if it encounters a questions that has TriggersSubQs set to “true”, it queries the database for all nested questions that have that primary question as a trigger. It then creates two panels: one for a “Yes” response, and one for a “No” response. The code places the nested questions on the appropriate response panel and places the panels in the table row directly beneath the primary question. If the primary question has a response of “Yes”, the “No” panel is hidden, and vice versa. If no response has been given, both panels are hidden. Questions that trigger sub-questions are also given the AutoPostBack attribute, so that when one of the radio buttons is clicked, the UpdatePanel it resides on refreshes with the correct response panel showing.

As FileUpload controls are created, an ArrayList is created, which contains all of the Attachments that have been uploaded for those controls. After all question controls are created, the code goes through this ArrayList and adds those Attachments to tables beneath the appropriate FileUpload controls.

FATCA Implementation Model: In one embodiment of the present invention, the systems and methods according to this invention may be configured to comply with FATCA in an efficient and sophisticated manner.

The SURETY CDD-FATCA System extends SURETY-CDD by enhancing it to serve the needs of FATCA compliance for financial institutions. It does so by efficiently scanning high volumes of customer files for US Indicia on a nightly basis, importing suspected US Indicia as detected according to a combination of full-record keyword scan and detailed field-level logic rules. Once imported, the financial institution can use the full power of SURETY-CDD to satisfy all their FATCA information collecting and reporting requirements.

Filtered Data Flow: In one embodiment of the present invention, the system is designed to be able to handle hundreds of millions of customer records per day with a high degree of confidence in resulting hits. To support this, the input data goes through a series of filters. Each filter reduces the flow of information to only those customer records that pass the test for that filter. By ordering the filters so that simple tests are first and complex tests are last, the system maximizes both high throughput and sophisticated matching logic.

Input from Multiple Sources: In one embodiment of the present invention, the system can accept input from an unlimited number of source data systems. Each source system simply outputs its data in its own format as files to its own handoff directory. The data passes through the first filter in its original format. Output from the first filter is then converted to the SURETY-CDD universal format that simplifies and streamlines the logic of the remaining filters.

System Components: In one embodiment of the present invention, this system consists of two executables, FATCAMON and SURETY CDD-IMPORT, as well as specific enhancements to the SURETY-CDD website application and database.

In one embodiment of the present invention, FATCAMON is the executable that implements the first filter in the system. Its purpose includes to scan source data files in their original format against a configured list of keywords. Any input record that contains one or more of the keywords, anywhere in the record, is included in the output in its original format. Other records that do not contain any of the keywords are omitted from the output.

To support multiple input sources and formats, FATCAMON is also configured with a list of input specifications, each of which includes: i) Full path to the directory at which the source system will output its data files (the handoff directory); ii) Block length of the input file format; and iii) Pattern that identifies a block that starts a new record.

In this way, the system can support full-record keyword scans for any of the currently known banking system data output formats, because all such formats can be reduced to a fixed block length, even though a single record can span multiple blocks.

Output records are all written as individual files with unique filenames to an output directory that corresponds to the original handoff directory. There is a one to one correspondence between handoff directories and FATCAMON output directories, to keep the different file formats flowing through this system separated.

FATCAMON can be run in either of two modes: (1) As a Windows Service, FATCAMON continually monitors the handoff directories and immediately processes any new files as they arrive; or (2) As a Nightly Job, FATCAMON scans each handoff directory once, processing all of the files found therein, and terminates.

SURETY CDD-IMPORT: In one embodiment of the present invention, SURETY CDD-IMPORT is an executable that implements the remaining filters of the system data flow. Its purpose is to import data records of any format, subject to the following constraints: (i) The record is determined to be a hit by one or more configurable rules that work against field-level logic; and (ii) The record is either new or changed since the last import.

To support this purpose, SURETY CDD-IMPORT is highly configurable. Its configuration includes Input Specifications, File Conversion Plug-ins, Configurable Rules, and connection information to a SURETY-CDD database.

Input Specifications: In one embodiment of the present invention, each Input Specification tells SURETY CDD-IMPORT where and how to pick up FATCAMON output. It therefore includes: (i) Full path to one FATCAMON output directory; and (ii) String that uniquely identifies the file format for files in that directory.

File Conversion Plug-ins: In one embodiment of the present invention, SURETY CDD-IMPORT includes an API (Application-Programming-Interface) that supports the development and setup of File Conversion Plug-ins. Each such plug-in reads file input in one format and outputs the same data in the SURETY-CDD universal format. SURETY CDD-IMPORT can thus be extended to support an unlimited number of input file formats, because a plug-in can be created to handle any format. This flexibility allows SURETY CDD-FATCA to tie easily into any existing financial institution.

Configurable Rules: In one embodiment of the present invention, SURETY CDD-IMPORT includes a flexible architecture for supporting an unlimited number of configurable rules, each of which can work against records in a SURETY-CDD database, or against files in the SURETY-CDD universal format.

The architecture supports easily configured rules based on predefined rule templates, which allows end users with less technical knowledge to adapt the system to their particular needs. Where additional configuration beyond that supported by existing rule templates is required, developers can easily add new rule templates by adding a single stored procedure that encapsulates the rule logic, and rows to a few well-documented tables that expose the stored procedure as a rule template, and tells the system what configurable parameters the template supports. For each single template, end users can create an unlimited number of specific rules, each with their own values for each of the configurable parameters exposed by the template.

When rules are run in the context of the SURETY CDD-FATCA system, they always run against FATCAMON output files that have first been converted to the universal format via the appropriate File Conversion Plug-in. These files in universal format are then stored in temporary database tables against which the stored procedure runs. When the rule identifies a record as a hit, it passes the second filter and is considered for input to SURETY-CDD. The final filter determines whether or not the hits are new or changed records, and accordingly either adds new records to SURETY-CDD or updates changed records.

Enhancements to SURETY-CDD: In one embodiment of the present invention, SURETY-CDD is enhanced for the SURETY CDD-FATCA system via the addition of tables and API as required by the FATCAMON and SURETY CDD-IMPORT executables. The SURETY-CDD user interface already includes all the flexibility and features needed to view and work with customer records, configure and test rules, etc.

The above description is illustrative only, not restrictive. Embodiments and aspects thereof may be used in combination with each other. Additionally, various modifications may be made to the above teachings to adapt a solution to a particular problem without departing from the scope of the invention.

Dimensions and types of materials described in the description of this invention are merely exemplary embodiments, they are not intended to be limiting. Various additional embodiments could be apparent to those skilled in the art. Therefore, the scope of the invention should be determined with reference to the appended claims, along with the full scope of equivalents to which such claims are entitled.

This above specification of this invention uses various examples to describe several embodiments of the invention, including the best mode. The patentable scope of the invention is defined by the claims, and is not limited by the above mentioned examples. A person skilled in the art may identify other examples that fall within the scope of the invention.

Additionally, the foregoing description of certain embodiments of the present invention may be better understood when read in conjunction with the drawings. The functional blocks in the drawings of various embodiments are not necessarily indicative of the division between hardware circuitry. Therefore, one or more of the functional blocks may be implemented in a single piece of hardware. For clarity, the various embodiments are not limited to the arrangements and instrumentalities shown in the drawings.

An element or step recited in the singular (i.e., “a” or “an”) should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Additionally, unless explicitly stated to the contrary, embodiments “comprising,” “including,” or “having” an element or a plurality of elements having a particular property may include additional such elements not having that property.

Certain modifications may be made in the methods and systems described herein. Therefore, the above description, including the accompanying drawings, are intended to be interpreted as mere examples illustrating the inventive concept and shall not be construed as limiting the invention.

What is claimed:

1. A computer readable medium having instructions for causing a computer to execute a computer-implemented method for financial regulatory compliance, comprising:
gathering data relating to a customer,
determining characteristics specific to the customer,
generating a risk score that assesses the probability of compliance with a financial regulation.

2. The computer-implemented method according to claim 1, further comprising:
storing the data relating to the customer in a custom database.

3. The computer-implemented method according to claim 2, further comprising:
calculating a dynamic multi-dimensional risk model based on the data relating to the customer in the custom database.

4. The computer-implemented method according to claim 3, further comprising:
a risk model manager for creating the dynamic multi-dimensional risk model, wherein the risk model may account for up to one thousand risk factors.

5. The computer-implemented method according to claim 3, further comprising:
a risk model manager for creating the dynamic multi-dimensional risk model, wherein the risk model uses a weighted average modeling, including at least one risk factor, at least one factor weight, and at least one factor alias name.

6. The computer-implemented method according to claim 5, further comprising:
a means for overriding the at least one risk factor.

7. The computer-implemented method according to claim 5, wherein the at least one risk factor is defined by its meta data.

8. The computer-implemented method according to claim 7, wherein the meta data describes associated data elements that form the at least one risk factor.

9. The computer-implemented method according to claim 7, wherein the data elements include at least one of a source table of risk factor items; a source table of score field definitions; a source table of primary key definitions; a source table score data types; a response table location; response field definitions; response primary key definitions; or foreign keys definitions.

10. The computer-implemented method according to claim 7, wherein a dynamic question generation engine is used to determine the characteristics specific to the customer.

11. A computer-implemented system for financial regulatory compliance, comprising:
a computer readable medium storing computer instructions;
an input medium for gathering data relating to a customer;
a database for storing the data relating to the customer;
a processor executing the computer instructions for determining characteristics specific to the customer and for generating a risk score that assesses the probability of compliance with a financial regulation; and
an output medium.

12. The computer-implemented system for financial regulatory compliance of claim 11, wherein the processor calculates a dynamic multi-dimensional risk model based on the data stored in the database.

13. The computer-implemented system for financial regulatory compliance of claim 12, wherein the data stored in the database further includes at least one of a source table of risk factor items; a source table of score field definitions; a source table of primary key definitions; a source table score data types; a response table location; response field definitions; response primary key definitions; or foreign keys definitions.

14. The computer-implemented system for financial regulatory compliance of claim 12, wherein the computer instructions cause the processor to execute a dynamic question generation engine used to determine the characteristics specific to the customer.

15. A means for ensuring financial regulatory compliance, comprising:
means for gathering data relating to a customer,
means for determining characteristics specific to the customer,
means for generating a risk score that assesses the probability of compliance with a financial regulation.
